(19) United States
(12) Patent Application Publication
(10) Pub. No.: US 2006/0080820 A1
(43) Pub. Date: Apr. 20, 2006

(54) Method and apparatus for a reducing surface area profile required for a gasket part cut from a sheet of gasket material

(76) Inventor: Adam Thomas Belote, Moscow, ID (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/968,607

(22) Filed: Oct. 18, 2004

(51) Int. Cl. B23Q 17/00

(52) U.S. Cl. 29/407.05; 29/407.01

(57) ABSTRACT

Disclosed is a method and apparatus for reducing a surface area profile required for a gasket part cut from a sheet of gasket material. The method generally includes receiving or determining at least one property of the gasket material, and receiving or determining a final shape of the gasket. The final shape includes a final side wall width, a final side wall thickness and a final topology. The final topology is associated with a first surface area profile. Based on the property(s) and the final shape, a contorted topology of the gasket is determined or calculated where the contorted topology is associated with a second surface area profile that is smaller than the first surface area profile. Once cut, the gasket with the contorted topology is selectively formable into the final topology.

### CROSS-REFERENCE TO RELATED APPLICATIONS

None

### BACKGROUND OF THE INVENTION

This disclosure relates to a method for cutting soft gasket parts from sheets of gasket material, and more particularly to a method and apparatus for reducing a surface area profile required for a gasket part cut from a sheet of gasket material.

Ideally, a part cut from flexible material is formed by cutting the final part shape from a large sheet of the flexible material. For example, a soft gasket used in a panel or cabinet mounted electronic component, is formed by cutting the final gasket shape from a large sheet of gasket material. Because the gasket material is often highly specialized and relatively costly, it is desirable to maximize the number of gaskets per sheet of gasket material and minimize the resulting gasket material waste.

Despite attempts to minimize gasket material waste via the use of efficient cutting die layouts, a large amount of gasket material waste remains, especially when the gasket shape includes a large aperture. For example, when a rectangular gasket has a narrow side wall and includes a proportionally large rectangular aperture, the rectangular aperture typically becomes gasket material waste. The problem compounds as the gasket surface area profile, or footprint, on the sheet of gasket material increases. As a result, the cost of the gasket increases proportional to its size.

A number of methods have been suggested to reduce the surface area profile of a larger gasket on a sheet of gasket material in order to optimize gasket material usage and minimize gasket cost. One method proposes segmenting the gasket shape into pieces that are readily nestable on the sheet of gasket material. The pieces are then fitted together via one of many suitable methods (e.g., application of hot melt between piece edges, interlocking the piece edges) to form the final gasket. While optimizing gasket material usage, the resulting gasket may suffer from weak joints, uneven wear, and/or provide a failure point in a subsequent application. In addition, labor associated with fitting together the gasket pieces may add to the final cost of the gasket. Another method proposes the use of less expensive gasket material sheets. Again, gasket reliability may be compromised.

### SUMMARY OF THE INVENTION

The method and apparatus for reducing a surface area profile required for a gasket part cut from a sheet of gasket material disclosed herein improves on the prior art in a number of ways. Among other things, it enables the number of gaskets cut per sheet of gasket material to be maximized while minimizing the gasket material waste. Accordingly, the cost of resulting gaskets is minimized. The method for reducing the surface area profile required for a gasket cut from a sheet of gasket material disclosed herein also achieves seamless gaskets that do not require mechanical assembly using adhesive welds or the like. Accordingly, gasket reliability and performance is maximized. Although described in terms of gaskets, the method and apparatus disclosed herein is applicable to any part cut from any suitable flexible material.

In summary, the invention is generally directed to increasing the number of a plurality of parts cut from a sheet of flexible material. Each of the plurality of parts has a final topology associated with a first surface area profile. The method includes providing the sheet of flexible material, determining a contorted topology for each of the plurality of parts where the contorted topology is selectively formable into the final topology and where the contorted topology is associated with a second surface area profile that is smaller than the first surface area profile, and cutting the plurality of the parts having the contorted topology from the sheet of flexible material.

The invention is particularly suited to gaskets cut from a sheet of gasket material. Accordingly, the invention is also directed to a method for reducing a surface area profile required for a gasket part cut from a sheet of gasket material. The method for reducing a surface area profile required for a gasket part cut from a sheet of gasket material includes: receiving or determining at least one property of the gasket material, and receiving or determining a final shape of the gasket where the final shape includes a final side wall width, a final side wall thickness and a final topology associated with a first surface area profile. Based on the property and the final shape, a contorted topology of the gasket is determined or calculated where the contorted topology is associated with a second surface area profile that is smaller than the first surface area profile. Once cut, the gasket with the contorted topology is selectively formable into the final topology.

The invention is further directed to a method for increasing the number of gaskets cut from a sheet of gasket material where each of the gaskets has a flexible side wall extending contiguously around an aperture and is adapted to have a final shape. The final shape includes a final side wall width, a final side wall thickness and a final topology having a first surface area profile. The method includes providing the sheet of gasket material and determining a contorted topology for each of the gaskets where the contorted topology is selectively formable into the final topology and where the contorted topology has a second surface area profile that is smaller than the first surface area profile. The method also includes determining a layout pattern of the gaskets in the contorted topology where the gaskets in the contorted topology are in close proximity to one another in the layout pattern, and cutting the gaskets in the contorted topology based on the layout pattern.

Moreover, the method and apparatus disclosed herein is applicable to any part molded from a flexible material and may therefore be used to increase the number molded gaskets per fixed surface area where each of the molded gaskets has a final shape and where the final shape has a final topology with a first surface area profile. The method includes determining a contorted topology of each of the molded gaskets where the contorted topology is selectively formable into the final topology. The contorted topology has a second surface area profile smaller than the first surface area profile. The method also includes determining a layout pattern of a number of contorted gasket molds where each of the contorted gasket molds corresponds to, and is adapted to form one of the molded gaskets having the contorted topology. The layout pattern is configured to maximize the number of contorted gasket molds situated in the fixed surface area. The method further includes forming the molded gaskets having the contorted topology using the layout pattern.

Other objects, advantages and novel features of the present disclosure will become apparent from the following detailed description when considered in conjunction with the accompanying drawings.

### BRIEF DESCRIPTION OF THE DRAWINGS

FIG. 1 is a perspective view of an exemplary power system component utilizing a soft gasket.

FIG. 2 is a top view of a sheet of gasket material including a layout pattern of a number of gaskets having a final rectilinear topology.

FIG. 3 is a top view of a number of nested gaskets having a contorted topology according to an embodiment of the invention.

FIG. 4 is an exemplary gasket shaping apparatus in accordance with an embodiment of the invention.

FIG. 5 is a flowchart of a gasket shaping routine that may be performed by the computer assembly of the gasket shaping apparatus of FIG. 4.

FIG. 6 is a top view of the sheet of gasket material including a layout pattern of a number of gaskets having a contorted topology in accordance with an embodiment of the invention.

FIG. 7 is a more detailed top view of one gasket of the layout pattern of FIG. 6.

### DETAILED DESCRIPTION

While the present disclosure may be susceptible to embodiment in different forms, there is shown in the drawings, and will be described herein in detail, one or more embodiments with the understanding that the present description is to be considered an exemplification of the principles of the disclosure and is not intended to be exhaustive or to limit the disclosure to the details of construction and the arrangements of components set forth in the following description or illustrated in the drawings.

Although described in terms of gaskets cut from a sheet of gasket material, the method and apparatus disclosed herein is applicable to any part cut or formed (e.g., molded) from a suitable flexible material. For example, the methods and apparatus disclosed herein may be used to cut foam padding used in furniture shipment and the like.

Gaskets may be utilized in many types of assemblies for many different purposes such as to provide fluid restriction, weather insulation, vibration dampening, electrical absorption, noise reduction, packaging, cushioning, to name a few. A gasket can therefore be cut into one of any number of shapes. Likewise, gaskets may be made from one of many types of materials, for example, fabric such as felt or compressed asbestos fiber, foam, fabric over foam, polymeric or rubber materials such as silicon rubber or neoprene, elastomeric materials such thermoplastic elastomers, metallic materials such as nickel utilized in nickel-plated polymer base gaskets, etc.

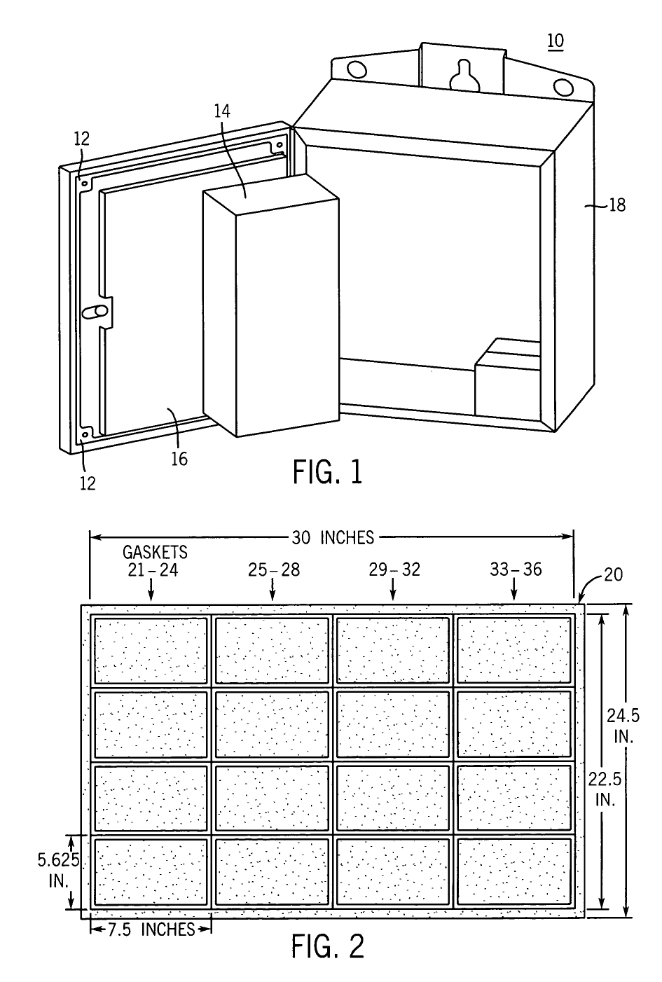

For example, FIG. 1 is a perspective view of an exemplary power system recloser control enclosure 10 utilizing a soft gasket 12. A door 16 provides access to a relay module 14 and other components positioned inside a recloser control enclosure chassis 18. In the illustrated example, the soft gasket 12 is mounted to an interior edge surface of the door 16 to prevent dust, contaminants, etc., from entering the interior of the recloser control enclosure chassis 18 when the door is closed. Although utilized as a seal in the recloser control enclosure 10, gaskets such as the soft gasket 12 may be used for many other applications with a variety of apparatus, for example, to provide a seal between joints in a hydraulic system or to provide a seal for a refrigerator.

Soft gaskets, typically cut from a flexible material, may be manufactured using one of any number of suitable methods. For example, a number of soft gaskets may be cut from a sheet of gasket material via a computer-controlled method such as a computer-controlled laser, a computer-controlled water jet, a computer-controlled cutting armature, etc. Soft gaskets may also be cut from a sheet of gasket material via a die tool having a pre-arranged cutting surface. Such a die tool may be constructed from an assemblage of individual die punches where each die punch of the die punch assemblage is configured to cut one gasket. The die tool may also be constructed using one or more ribbon-like metal strip(s) disposed in a continuous channel to provide the cutting edge to simultaneously cut a number of contiguous gaskets or proximate gaskets. Computer-controlled laser etching of die press plates may also be used to construct the die tool.

Gaskets are typically cut in their final shape from a sheet of gasket material and, as a result, a large percentage of relatively costly gasket material is wasted. For example, FIG. 2 is a top view of a 24.5×32×0.25 inch sheet of gasket material 20 yielding a number of gaskets in a final rectilinear shape. Although preferably a sheet of non-stabilized foam rubber, the sheet of gasket material 20 may be any suitable flexible gasket material. Sixteen rectilinear 5.625×7.50 inch gaskets 21-36 are contiguously positioned on the 24.5×32×0.25 inch sheet of gasket material 20 while still allowing a 1.0 inch margin of gasket material around the perimeter edges. In the illustrated example, each of the sixteen gaskets 21-36 has a final side wall width of 0.375 inches and a final side wall thickness of 0.25 inches. When cut in a final rectilinear shape, each of the gaskets 21-36 has a rectilinear topology defined by a flexible 0.375×0.25 inch side wall extending contiguously about a 32.9 square inch rectangular aperture. Thus, each of the gaskets 21-36 utilizes approximately 9.3 square inches (42.2 square inches minus 32.9 square inches) from a 42.2 square inch surface area profile of gasket material, resulting in 37.4 square inches of gasket material waste. Although illustrated using rectilinear shaped gaskets with contiguous peripheral side walls, other final shapes such as, for example, circular shapes, “U” shapes and “C” shapes may be similarly positioned.

As previously mentioned, increasing the number of gaskets cut per sheet of gasket material 20 decreases the gasket material waste. Thus, it is desirable to maximize the number of gaskets cut from the sheet of gasket material 20. As illustrated in FIG. 2 however, the allowable number of gaskets cut from a sheet of gasket material 20 is limited when the gaskets are cut in their final shape.

A method and apparatus for reducing the surface area profile required for a gasket part cut from a sheet of gasket material is disclosed herein. A gasket, having a flexible peripheral side wall extending contiguously about a central aperture, is configured having a contorted topology during the cutting process. After cutting, the gasket is formed into its final shape. The contorted topology is selected such that its associated surface area profile is smaller than the surface area profile of the topology of the final shape. As a result, the number of gaskets cut from a sheet of material may be maximized thereby reducing gasket material waste.

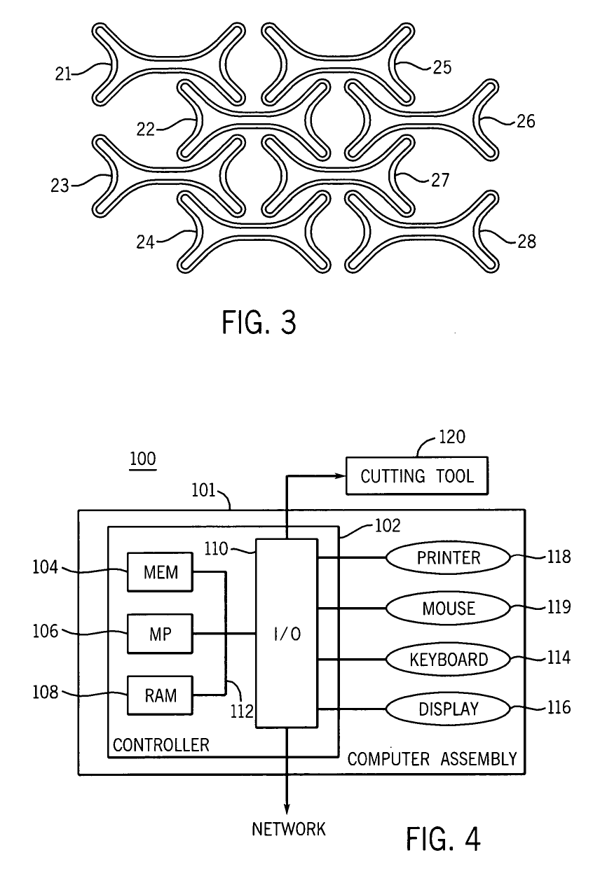

For example, FIG. 3 is a top view of a number of nested gaskets having a contorted topology according to an embodiment of the invention. The nested gaskets have a rectilinear final shape. As illustrated, by advancing opposing sides of a rectilinear gasket (e.g., the 5.625×7.50 square inch gasket of FIG. 2) towards each other, a “folded-X” topology is created where the central aperture is minimized. As a result, the surface area profile of the gasket is minimized and more gaskets can be cut from a sheet of gasket material. Although illustrated utilizing the folded-X shape, it is contemplated that any contorted shape, for example, a “folded-U” shape yielding a smaller surface area profile than its respective final topology, may be used in the layout pattern.

Once cut, each of the contorted gaskets having the folded X topology are selectively formable into gaskets having final desired topologies such as the 5.625×7.50 square inch rectilinear topology of FIG. 2. The ability of each of the gaskets having contorted topologies to be formable into gaskets having final topologies, or the degree to which particular contorted topology may be formable into a final rectilinear topology, depends on a number of factors. These factors include (1) properties of the sheet of gasket material from which the gaskets are cut and (2) dimensions of the final desired shape of the gasket when mounted on or between components such as the door and chassis of the recloser control enclosure 10 of FIG. 1. In addition, final placement of the gasket may be a factor in determining the degree to which particular contorted topology may be formable into the final rectilinear topology. For example, the degree to which a particular contorted topology may be formable into a final rectilinear topology may be affected by whether the gasket is reinforced into its final shape by coating it with a stiffener material, by fastening it to a solid surface, or by inserting corner supports, to name a few.

Based on the properties of the sheet of gasket material from which the gaskets are cut, and the dimensions of the final desired shape of the gasket, a variety of contorted, or curvilinear or other non-rectilinear, shapes having smaller surface area profiles (than their final surface area profiles) may be determined or calculated. Further, once determined, gasket shapes having contorted topologies with smaller surface profile areas can be arranged into layout patterns (e.g., a grouping of identical contorted topologies, a grouping of dissimilar contorted topologies) and can then be utilized to build a die board for cutting the gaskets having contorted topologies from the sheet of gasket material 20. The layout patterns may also be utilized by a computer to cause a cutting tool (e.g., a laser, a water jet, a cutting armature) to cut the contorted shapes directly from the gasket material.

For example, FIG. 4 is an exemplary gasket shaping apparatus 100 for (1) determining contorted topologies for gaskets based on associated gasket material properties and final shapes, (2) determining layout pattern(s) for the gaskets having the contorted topologies, and (3) causing the layout pattern(s) to be transferred to a die board and/or (4) causing a cutting tool to cut the gaskets directly from the sheet of gasket material 20 based on the layout pattern(s).

Referring to FIG. 4, the gasket shaping apparatus 100 includes computer assembly 101 and an optional cutting tool 120. The computer assembly 101 includes a controller 102 that may include a program memory 104 (including a read only memory (ROM)), a microcontroller-based platform or microprocessor (MP) 106, a random-access memory (RAM) 108 and an input/output (I/O) circuit 110, all of which may be interconnected via a communications link, or an address/data bus 112. The optional cutting tool 120 may be one of any number of suitable gasket cutting tools, for example, a laser. In addition, the computer assembly 101 may be in communication with one or more network elements via any suitable network connection such as an Ethernet connection, a modem connection, an 802.11 connection, etc.

The microprocessor 106 is capable of performing, among other things, calculations such as Bezier curve calculations for determining contorted topologies, determining layout patterns, causing the layout patterns to be displayed and causing the cutting tool 120 to cut the sheet of gasket material 20 using the layout patterns. The RAM 108 is capable of storing data used or generated during calculations, layout pattern determination, etc. The program memory 104 is capable of storing program code that calculates contorted topologies, determines layout patterns and controls operation of the gasket shaping apparatus 100. For example, based on the properties of the gasket material and the dimensions of the final desired shape of the gasket entered via a data input device such as a keyboard 114, the microprocessor 106, executing code in the program memory 104, determines one or more possible contorted shapes.

Although only one microprocessor 106 is shown, the controller 102 may include multiple microprocessors. Similarly, additional memory (e.g., flash memory) may be included, depending on the requirements of the gasket shaping apparatus 100. The RAM(s) 108 and program memory(s) 104 may be implemented as semiconductor memories, magnetically readable memories, and/or optically readable memories, etc.

In addition to the controller 102 and the keyboard 114, the computer assembly 101 may also include a display 116, a printer 118 and a mouse 119, all operatively coupled to the I/O circuit 110. Although four peripheral devices are depicted, more or less peripheral devices may be included in the computer assembly 101.

One manner in which the computer assembly 101 may operate is described below in connection with one or more flowchart(s) that represents a number of portions or routines of one or more computer programs, which may be stored in one or more of the memories of the controller 102. The computer program(s) or portions thereof may also be stored remotely, outside of the computer assembly 101 and may therefore control the operation from a remote location.

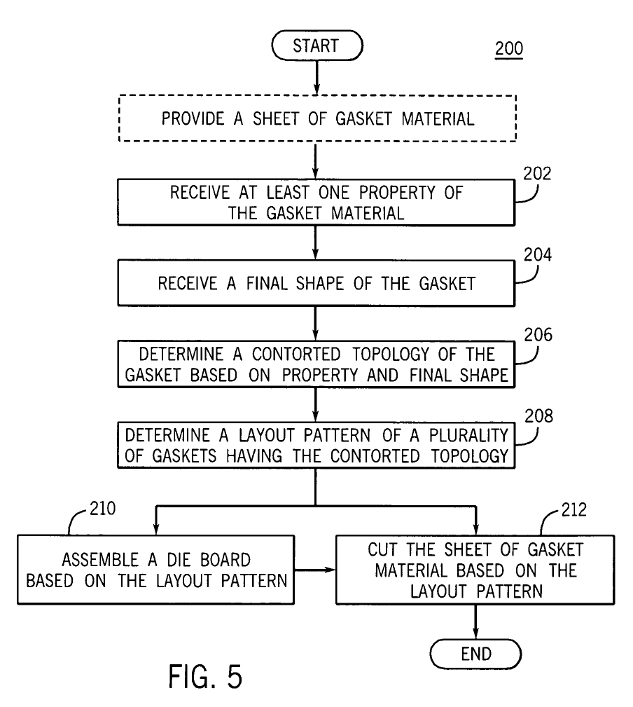

FIG. 5 is a flowchart of a gasket shaping routine 200 that may be performed by the computer assembly 101. Referring to FIG. 5, the gasket shaping routine 200 begins when the controller 102 receives or determines at least one property of the gasket material of the sheet of gasket material 20 (step 202). The properties may include one or more of the tensile strength, the flexibility, the elasticity, the density, the compressibility and the hardness of the gasket material. The property(s) may be received or determined by the controller 102 in one of a number of ways. For example, an operator may manually enter the gasket material property data via the keyboard 114 or the gasket material property data may be downloaded from a coupled device such as a coupled server.

The controller 102 also receives or determines the final shape of the gasket (step 202). The final shape includes a final side wall width, a final side wall thickness and a final topology (e.g., 0.375 inch wide×0.25 inch thick rectilinear shape) of the gasket. The dimensions of the final shape may be received by the controller 102 in one of a number of ways. For example, an operator may manually enter the final gasket shape data via the keyboard 114 or via clicking with mouse 14 on dimension selections displayed on the display 116. Final placement of the gasket may also be received or determined by the controller 102 in cases where, for example, a stiffener material is used, reinforcing supports are used.

Next, using the property data and the final shape dimension data, the controller 102 determines or calculates one or more suitable contorted topologies (step 206) that yield the smallest surface area profile while allowing the gasket to be formed (e.g., unfolded, detangled, stretched, un-swirled) into its respective final shape. In some cases however, it may only be necessary to consider the final shape dimension data to determine suitable contorted topologies. Determining one or more suitable contorted topologies may be accomplished by the controller 102 in one of a number of ways. For example, using the property data, the final shape dimension data and a Bezier curve parametric equation, the controller 102 may calculate a curvilinear topology, where the curvilinear topology has a smaller surface area profile than the final rectilinear topology.

In addition to calculating curvilinear topologies, the controller 102 may determine other suitable contorted topologies that also yield smaller surface area profiles than their respective final topologies. For example, the controller 102 may determine that a rectilinear gasket can be contorted into a suitable shape having a swirled or folded topology. Once determined, the controller 102 or an operator may select from among the suitable shapes displayed on the computer assembly 101.

After one or more suitable gasket shapes having contorted topologies are determined, they can be arranged into layout patterns that minimize gasket material waste, for example, they can be arranged into a grouping of nested identical contorted topologies or into a grouping of dissimilar contorted topologies (step 208) (see, FIG. 3).

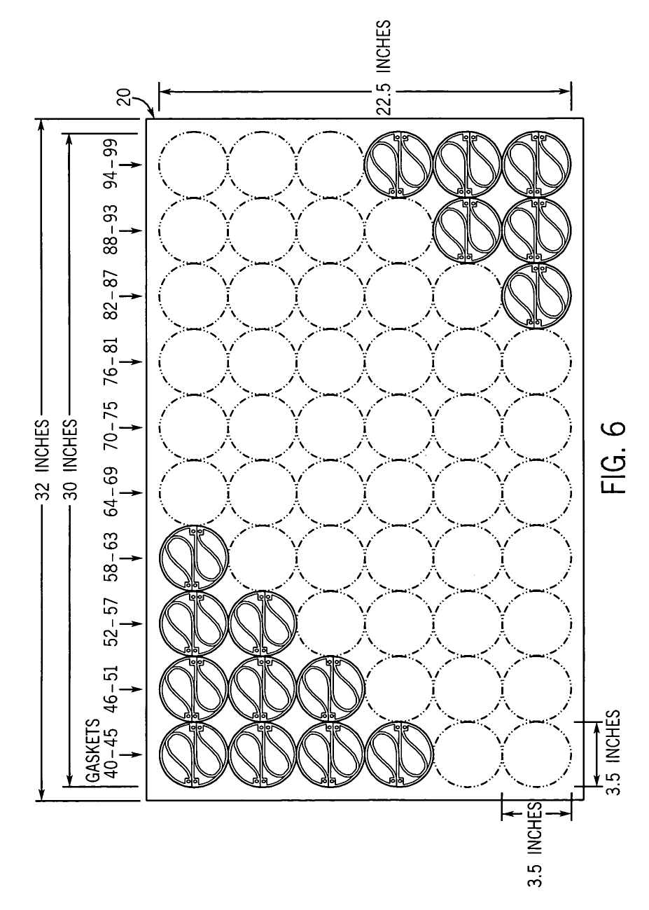

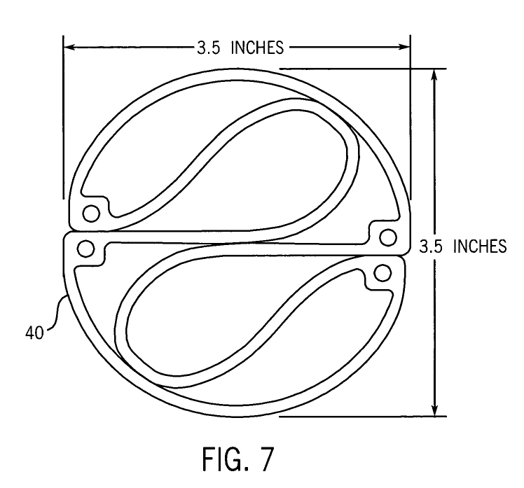

FIG. 6 is a top view of the sheet of gasket material 20 yielding a number of gaskets having a contorted topology in accordance with an embodiment of the invention. Sixty 5.625×7.50 square inch gaskets 40-99 are contiguously positioned on the 24.5×32×0.25 inch gasket material 20 while still maintaining at least a 1.0 inch perimeter margin. Unlike the gaskets 21-36 of FIG. 2, the gaskets 40-99 are not laid out in their final rectilinear gasket shape. Instead, each of the gaskets 40-99 is laid out in a curvilinear shape having a contorted topology with a 3.5×3.5 square inch surface area profile (see, FIG. 7). Accordingly, each of the gaskets 40-99 utilizes approximately 9.3 square inches of gasket material from a 12.25 square inch surface area profile, resulting in only 2.95 square inches of gasket material waste; much less than the 32.9 square inches of gasket material waste associated with the rectilinear gaskets 21-36 of FIG. 2.

Referring again to FIG. 5, the layout pattern(s) determined by the controller 102 or by the operator may then be utilized to build a die board for cutting the gaskets from the sheet of gasket material 20 (210). The layout patterns may also be utilized by a computer to cause a cutting tool (e.g., a laser, a water jet, a cutting armature) to cut the gaskets directly from the gasket material (212).

As mentioned above, in addition to the rectilinear shaped gaskets described herein, the method and apparatus for reducing the surface area profile required for a gasket part is applicable to gaskets having other final shapes. For example, the method and apparatus for reducing the surface area profile required for a gasket part is applicable to O-rings, “C”-shaped gaskets, “U”-shaped gaskets, etc. Further, the method and apparatus for reducing the surface area profile required for a gasket part expands existing die cutting capability by cutting gaskets or other similar parts in their contorted topology rather than in their final topology. As a result, a large gasket having a final topology (e.g., 35 inches by 45 inches) that exceeds the size of the sheet of gasket material (e.g., 25.5 inches by 32 inches) may nonetheless be cut, via a contorted topology, from the sheet of gasket material.

Moreover, the method and apparatus disclosed herein is applicable to any part cut or cast (e.g., molded) from a flexible material. For example, the method and apparatus disclosed herein may be used to increase the number molded gaskets per fixed surface area where each of the molded gaskets has a final shape and where the final shape has a final topology with a first surface area profile. First, a contorted topology of each of the molded gaskets is determined where the contorted topology is selectively formable into the final topology. The contorted topology has a second surface area profile smaller than the first surface area profile. Next, a layout pattern of a number of contorted gasket molds is determined where each of the contorted gasket molds corresponds to, and is adapted to form one of the molded gaskets having the contorted topology. The layout pattern is configured to maximize the number of contorted gasket molds situated in the fixed surface area. Finally, the molded gaskets having the contorted topology are formed using the layout pattern.

As may be apparent from the above discussion, the method and apparatus for reducing the surface area profile required for a gasket part optimizes gasket material usage while still maintaining gasket reliability. When utilizing the method and apparatus disclosed herein, there is no need to segment the gasket into smaller pieces to minimize gasket material waste and there is no need to use less expensive gasket material to minimize gasket cost. Further, although gaskets are used to illustrate the various embodiments, the method and apparatus disclosed herein is applicable to any part cut or molded from a suitable flexible material.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicant has provided description and figures which are intended as illustrations of embodiments of the disclosure, and are not intended to be construed as containing or implying limitation of the disclosure to those embodiments.

1. A method for increasing the number of a plurality of parts cut from a sheet of flexible material, each of the plurality of parts having a final topology associated with a first surface area profile, the method comprising:
providing the sheet of flexible material;
determining a contorted topology for each of the plurality of parts, the contorted topology selectively formable into the final topology, the contorted topology associated with a second surface area profile, the second surface area profile smaller than the first surface area profile; and
cutting the plurality of the parts having the contorted topology from the sheet of flexible material.

2. The method of claim 1, further comprising determining a layout pattern for the plurality of parts having contorted topologies prior to cutting the plurality of parts, the layout pattern maximizing the number of parts cut from the sheet of flexible material.

3. The method of claim 1, wherein determining the contorted topology for each of the plurality of parts comprises calculating the contorted topology based on the final shape.

4. The method of claim 1, wherein determining the contorted topology for each of the plurality of parts comprises:
receiving at least one property of the flexible material; and
based on the at least one property and the final shape, calculating the contorted topology.

5. A method for increasing the number of a plurality of gaskets cut from a sheet of gasket material, each of the plurality of gaskets having a flexible side wall extending contiguously around an aperture and adapted to have a final shape, the final shape including a final side wall width, a final side wall thickness and a final topology, the final topology having a first surface area profile, the method comprising:
providing the sheet of gasket material;
determining a contorted topology for each of the plurality of gaskets, the contorted topology selectively formable into the final topology, the contorted topology having a second surface area profile, the second surface area profile smaller than the first surface area profile; and
cutting the plurality of the gaskets having the contorted topology from the sheet of gasket material.

6. The method of claim 5, wherein determining the contorted topology for each of the plurality of gaskets comprises calculating the contorted topology based on the final shape.

7. The method of claim 5, wherein determining the contorted topology for each of the plurality of gaskets comprises:
receiving at least one property of the gasket material; and
based on the at least one property and the final shape, calculating the contorted topology.

8. The method of claim 7, wherein the contorted topology is selected from the group consisting of a Bezier curvilinear shaped topology, a folded alphabet letter-shaped topology, and a generally non-rectilinear shaped topology.

9. The method of claim 5, wherein cutting the plurality of the gaskets having the contorted topology comprises:
determining a layout pattern of the plurality of gaskets in the contorted topology, wherein the plurality of the gaskets in the contorted topology are in close proximity to one another in the layout pattern; and
cutting the sheet of gasket material based on the layout pattern with a cutting tool.

10. The method of claim 5, wherein cutting the plurality of the gaskets in the contorted topology comprises:
determining a layout pattern of the plurality of the gaskets in the contorted topology, wherein the plurality of the gaskets in the contorted topology are in close proximity to one another in the layout pattern;
assembling a die board based on the layout pattern; and
cutting the sheet of gasket material with the die board.

11. The method of claim 10, wherein the layout pattern maximizes the number of gaskets cut from the sheet of gasket material.

12. The method of claim 5, wherein the final topology comprises a generally rectilinear shaped topology.

13. The method of claim 5, wherein the final topology comprises a generally circular shaped topology.

14. A method for increasing a number of molded gaskets per a fixed surface area, each of the molded gaskets adapted to have a final shape including a final topology, the final topology having a first surface area profile, the method comprising:
determining a contorted topology for each of the molded gaskets, the contorted topology selectively formable into the final topology, the contorted topology having a second surface area profile, the second surface area profile smaller than the first surface area profile;
determining a layout pattern of a plurality of contorted gasket molds, each of the plurality of contorted gasket molds adapted to form a molded gasket having the contorted topology, wherein the layout pattern maximizes the number of contorted gasket molds situated in the fixed surface area; and
forming a plurality of molded gaskets having the contorted topology using the layout pattern of the plurality of contorted gasket molds.

15. The method of claim 14, wherein determining the contorted topology for each of the plurality of molded gaskets comprises calculating the contorted topology based on the final shape.

16. The method of claim 14, wherein determining the contorted topology for each of the plurality of molded gaskets comprises:
receiving at least one property of the gasket material; and
based on the at least one property and the final shape, calculating the contorted topology.

17. The method of claim 16, wherein the contorted topology is selected from the group consisting of a Bezier curvilinear shaped topology, a folded alphabet letter-shaped topology, and a generally non-rectilinear shaped topology.

18. A method for reducing a surface area profile required for a gasket cut from a sheet of gasket material, the gasket having flexible peripheral side wall extending contiguously about a central aperture, the method comprising:
receiving at least one property of the gasket material;
receiving a final shape of the gasket, the final shape including a final side wall width, a final side wall thickness and a final topology, the final topology having a first surface area profile; and
based on the at least one property and the final shape, determining a contorted topology of the gasket, the contorted topology having a second surface area profile smaller than the first surface area profile.

19. The method of claim 18, wherein the contorted topology is selectively formable into the final topology.

20. The method of claim 18, wherein the at least one property is selected from the group consisting of tensile strength, flexibility, elasticity, density, compressibility and hardness.

21. The method of claim 18, wherein the final topology comprises a generally rectilinear shaped topology.

22. The method of claim 18, wherein the final topology comprises a generally circular shaped topology.

23. The method of claim 18, wherein the contorted topology comprises a Bezier curvilinear shaped topology.

24. The method of claim 18, wherein the contorted topology comprises a folded alphabet letter-shaped topology.

25. The method of claim 18, wherein the contorted topology comprises a generally non-rectilinear shaped topology.

26. A gasket for creating a seal between adjacent components, the gasket comprising:
a flexible peripheral side wall extending contiguously about a central aperture, the peripheral side wall being configured in a contorted shape, the peripheral side wall being selectively formable into a final shape, the final shape having a first surface area profile, the contorted shape having a second surface area profile that is smaller than the first surface area profile, whereby the contorted shape enables the gasket to be cut from a smaller area of gasket sheet material than a gasket cut in the final shape.

27. The gasket of claim 26, wherein the final shape comprises a generally rectilinear shape having a rectilinear topology.

28. The gasket of claim 26, wherein the final shape comprises a generally circular shape having a circular topology.

29. The gasket of claim 26, wherein the contorted shape comprises a Bezier curvilinear shape having a curvilinear topology.

30. The gasket of claim 26, wherein the contorted shape comprises a folded alphabet letter shape having an alphabet letter topology.

31. The gasket of claim 26, wherein the contorted shape comprises a generally non-rectilinear shape having a non-rectilinear topology.

32. An apparatus for increasing the number of a plurality of gaskets cut from a sheet of gasket material, the apparatus comprising:
a data input device;
a display; and
a controller operatively coupled to the data input device and display, the controller comprising a processor and a memory operatively coupled to the processor, the controller being programmed to:
receive at least one property of the gasket material,
receive a final shape of the gasket, the final shape including a final side wall width, a final side wall thickness and a final topology, the final topology having a first surface area profile, and
based on the at least one property and the final shape, determine a contorted topology of the gasket, the contorted topology having a second surface area profile smaller than the first surface area profile.

33. The apparatus of claim 32, wherein the controller is further programmed to determine a layout pattern of a plurality of gaskets having the contorted topology, wherein the plurality of the gaskets having the contorted topology are in close proximity to one another in the layout pattern.

34. The apparatus of claim 32, wherein the controller is further programmed to maximize the plurality of gaskets in the layout pattern.

35. The apparatus of claim 32, wherein the controller is further programmed to cause the sheet of gasket material to be cut based on the layout pattern.

36. The apparatus of claim 32, wherein the controller is further programmed to cause a die board to be assembled based on the layout pattern.
